(19) United States
(12) Patent Application Publication
(10) Pub. No.: US 2012/0026518 A1
(43) Pub. Date: Feb. 2, 2012

(54) Image Forming Apparatus, Toner Usage Evaluation Method, and Computer-Readable Non-Transitory Recording Medium Storing a Toner Usage Evaluation Program

(75) Inventor: Akira Nishizawa, Osaka (JP)

(73) Assignee: KYOCERA MITA CORPORATION, Osaka (JP)

(21) Appl. No.: 13/193,187

(22) Filed: Jul. 28, 2011

(30) Foreign Application Priority Data
Jul. 30, 2010 (JP) 2010-173145
Jul. 30, 2010 (JP) 2010-173146
Jul. 30, 2010 (JP) 2010-173147
Jul. 30, 2010 (JP) 2010-173148

(51) Int. Cl. H04N 1/60

(52) U.S. Cl. 358/1.9

(57) ABSTRACT

Provided is an image forming apparatus including a reference image generating unit and a toner usage evaluation unit. The reference image generating unit is configured to convert a subject image into a reference image having a data amount smaller than the subject image. The toner usage evaluation unit is configured to obtain a usage of toner for printing the subject image based on the reference image.

### REFERENCE TO RELATED APPLICATIONS

This application is based upon and claims the benefit of priority from the corresponding Japanese Patent Application No. 2010-173145, filed in the Japan Patent Office on Jul. 30, 2010, No. 2010-173146, filed in the Japan Patent Office on Jul. 30, 2010, No. 2010-173147, filed in the Japan Patent Office on Jul. 30, 2010, and No. 2010-173148, filed in the Japan Patent Office on Jul. 30, 2010, the entire contents of which are incorporated herein by reference.

### BACKGROUND

1. Technical Field

The present disclosure relates to an image forming apparatus of an electrophotographic process that performs an image forming process by using toner, in particular, a method for obtaining a toner usage and obtaining a billing amount based on the toner usage.

2. Description of the Related Art

A typical image forming apparatus of an electrophotographic process generally employs a billing system for billing a user for printing images or characters that use toner. A usage-based billing system for the billing based on an amount of used toner is known as one of the billing systems.

A dot-count system for obtaining a toner usage based on a product value obtained by multiplying a dot count value by a toner adhesion amount is known for obtaining a usage of toner in the usage-based billing system with high accuracy.

The dot-count system is a system in which a duration or frequency of light emission from a laser corresponding to pixels to be printed in the course of an image forming process is counted in units of dots and the count value is multiplied by the toner usage per dot to thereby calculate the toner usage for each color.

In the case of the image forming apparatus of the electrophotographic process, a relationship between the dot count value and the toner adhesion amount is nonlinear due to its dependence on continuity of dots. Therefore, in the dot-count system, first, print dot lines are classified into a plurality of patterns according to the continuous state of the dots, and the number of times a dot occurs is counted for each of the patterns. Then, a correction for multiplying each of the count values thus obtained by a specific coefficient is performed to thereby obtain the toner usage. Such a method of calculating the toner usage is generally a method of obtaining and accumulating the respective toner usages of all the pixels (dots) of a subject image.

Further, there is also known a method of calculating the toner usage based on a histogram obtained by summing up the number of pixels for each specific color value range.

The above-mentioned method of calculating the toner usage requires a long period of time to calculate the toner usage of an image having a large number of pixels. In particular, a massive load is imposed on creation of the histogram, which requires a long period of time to calculate the toner usage.

### SUMMARY

An image forming apparatus according to an embodiment of the present disclosure includes a reference image generating unit and a toner usage evaluation unit. The reference image generating unit is configured to convert a subject image into a reference image having a data amount smaller than the subject image. The toner usage evaluation unit is configured to obtain a usage of toner for printing the subject image based on the reference image.

A toner usage evaluation method according to another embodiment of the present disclosure includes: (i) a reference image generating unit converting a subject image into a reference image having a data amount smaller than the subject image; and (ii) a toner usage evaluation unit obtaining a usage of toner for printing the subject image based on the reference image.

A non-transitory computer-readable recording medium according to a further embodiment of the present disclosure stores a toner usage evaluation program code executed by a computer of an image forming apparatus. The toner usage evaluation program code includes a first sub-program code and a second sub-program code. The first sub-program code causes the computer to convert a subject image into a reference image having a data amount smaller than the subject image. The second sub-program code causes the computer to obtain a usage of toner for printing the subject image based on the reference image.

### BRIEF DESCRIPTION OF THE DRAWINGS

In the accompanying drawings:

FIG. 1 illustrates a configuration of an image forming apparatus according to embodiments of the present disclosure;

FIG. 2 illustrates a configuration of a computing unit of the image forming apparatus according to the embodiments of the present disclosure;

FIG. 3 illustrates a configuration of a weight evaluation parameter storage (WEPS) unit;

FIG. 4 illustrates a configuration of a billing evaluation parameter storage (BEPS) unit;

FIG. 5 illustrates a configuration of a toner usage prediction unit according to a first embodiment of the present disclosure;

FIG. 6 illustrates a configuration of a billing computing unit according to the first embodiment;

FIG. 7 illustrates a configuration of a toner usage prediction unit according to a second embodiment of the present disclosure;

FIG. 8 illustrates a configuration of a toner usage prediction unit according to a third embodiment of the present disclosure;

FIG. 9 illustrates a configuration of a billing computing unit according to the third embodiment;

FIG. 10 illustrates a configuration of a weight evaluation parameter storage (WEPS) unit according to a fourth embodiment of the present disclosure;

FIG. 11 illustrates a configuration of a basic computing unit according to the fourth embodiment;

FIG. 12 illustrates a configuration of a portion of a basic computing unit according to a fifth embodiment of the present disclosure;

FIG. 13 illustrates a configuration of a billing computing unit according to the fifth embodiment; and

FIG. 14 illustrates a configuration of a draft mode processing unit according to a sixth embodiment of the present disclosure.

### DETAILED DESCRIPTION

Hereinafter, embodiments of the present disclosure are described with reference to the accompanying drawings.

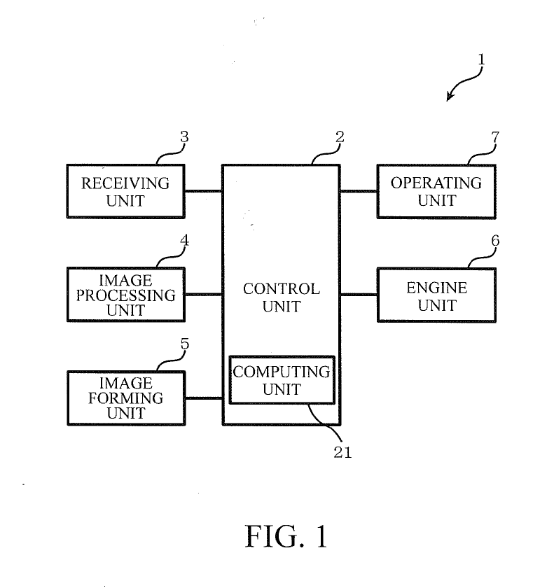

FIG. 1 illustrates a schematic configuration of an image forming apparatus according to the embodiments of the present disclosure.

As illustrated in FIG. 1, an image forming apparatus 1 includes control unit 2, receiving unit 3, an image processing unit 4, an image forming unit 5, an engine unit 6, and an operating unit 7.

Control unit 2 is configured as a computer including a CPU that executes a control program, a ROM that stores the control program and data, a RAM that functions as a work memory, and an I/O port. Control unit 2 executes the stored control program to control the respective components of image forming apparatus 1. Further, by executing a program, control unit 2 functions as computing unit 21 that executes various computation processes in order to control image forming apparatus 1. Computing unit 21 evaluates a toner usage and obtains a billing amount based on the evaluated toner usage.

Receiving unit 3 includes a network interface. Receiving unit 3 receives data (hereinafter, referred to as “image data”) on a document or an image that is transmitted from a client PC (personal computer, not shown) or the like via a network such as a local area network (LAN), and passes the image data to image processing unit 4.

Image processing unit 4 includes a rasterizer. Image processing unit 4 executes a rasterization process on the image data, and rasterizes the image data into pixels corresponding to its resolution to generate a rasterized image. Further, image processing unit 4 outputs the rasterized image to image forming unit 5 and to computing unit 21 of control unit 2.

The image data on a subject image is output both to image forming unit 5 that forms an image for printing and to computing unit 21 that obtains the toner usage, and hence a printing process and a toner usage evaluation process are performed independently of each other. That is, even if any modifications are performed on the image data used for evaluating the toner usage, the modifications do not influence on output image quality of a print image.

Image forming unit 5 includes an image processor. Image forming unit 5 color-converts color values (RGB values) of RGB components of the rasterized image into color values (CMYK values) of CMYK components that can be output via a first color conversion table. Image forming unit 5 separates the rasterized image into respective channels of cyan (C), magenta (M), yellow (Y), and black (K). In addition, image forming unit 5 executes a gamma correction process and a screen process as necessary, and outputs the resultant to engine unit 6.

Engine unit 6 includes a printing mechanism. Engine unit 6 forms a toner image on the photosensitive drum based on the image data output from image forming unit 5, and temporarily transfers the toner image onto a transferring belt. Subsequently, engine unit 6 executes the printing process for transferring the toner image on the transfer belt onto paper and fixing the toner image to the paper by a fixing roller.

Operating unit 7 is configured as, for example, a touch panel unit produced by combining a touch panel and a color liquid crystal display (LCD). Operating unit 7 displays various kinds of operation screens and further displays operation keys for inputting an operating instruction corresponding to a user's touch operation.

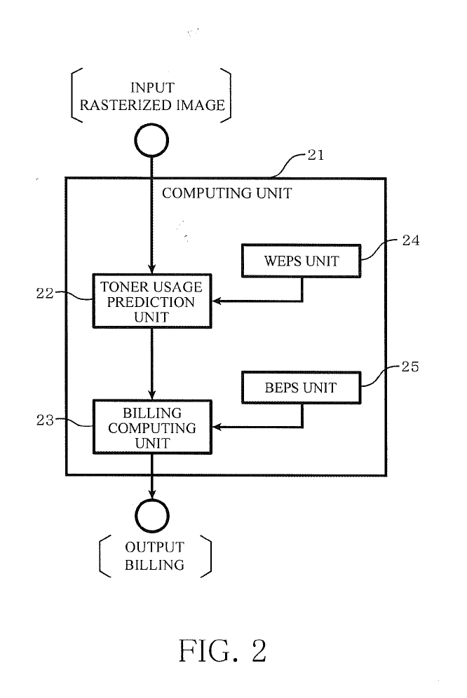

FIG. 2 illustrates a configuration of computing unit 21 of image forming apparatus 1.

Computing unit 21 includes, as illustrated in FIG. 2, toner usage prediction unit 22, billing computing unit 23, weight evaluation parameter storage (WEPS) unit 24, and billing evaluation parameter storage (BEPS) unit 25.

Toner usage prediction unit 22 predicts the toner usage regarding the rasterized image output from image processing unit 4 based on a weight evaluation parameter stored in WEPS unit 24. Billing computing unit 23 evaluates a charge based on a billing evaluation parameter stored in BEPS unit 25.

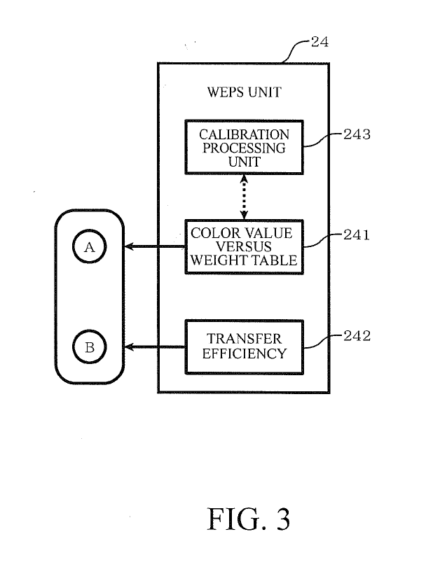

FIG. 3 illustrates a configuration of WEPS unit 24.

As illustrated in FIG. 3, WEPS unit 24 includes color-value-versus-weight table 241, transfer efficiency 242, and calibration processing unit 243.

Color-value-versus-weight table 241 includes a relationship between the color value and a transfer toner weight per unit area as the weight evaluation parameter. Color-value-versus-weight table 241 can be generated based on an actually measured value of a toner weight. For example, some color values are selected at specific color value intervals. A sample image (for example, a square, a circle, or other such images having a shape whose area is easy to obtain) formed of each of the selected color values is output (drawn), and the weight of toner adhering to the transferring belt is measured as the transfer toner weight. The weight of the adhering toner can be actually measured with a scale after collecting the adhering toner.

By dividing the measured transfer toner weight by the area of the sample image, the transfer toner weight per unit area can be obtained for each of cyan, magenta, yellow, and black on a color value basis. Then, by associating the obtained transfer toner weight per unit area with the color value corresponding thereto, color-value-versus-weight table 241 can be generated.

Transfer efficiency 242 indicates a ratio at which the toner adhering to the transferring belt is printed on the paper. By multiplying the transfer toner weight obtained via color-value-versus-weight table 241 by transfer efficiency 242, an on-paper toner weight can be obtained.

Note that, in creating color-value-versus-weight table 241, the weight of paper before printing (to which toner has not adhered yet) is previously obtained, the weight of the paper after printing the above-mentioned sample image is measured, and a difference there between can be set as the transfer toner weight. In this case, the transfer toner weight has the same value as the on-paper toner weight. That is, there is no need to multiply the transfer toner weight by transfer efficiency 242 in order to obtain the on-paper toner weight.

Calibration processing unit 243 executes a calibration each time the printing process is performed for a predetermined period of time or for a predetermined number of sheets.

The calibration is a process for correcting an input/output characteristic (gamma correction) so that a density (or brightness) of an image output according to the input of a given color value is kept constant even under the influence of an environmental change, a change over time, or the like. Specifically, printed dots are increased or decreased so as to obtain a constant input/output characteristic (for example, a curved shape of a gamma curve).

In other words, a print density corresponding to a given color value is constant, and the toner weight corresponding to the color value is also maintained at substantially the same value. Therefore, if the calibration functions effectively, the relationship between the color value and the toner weight per unit area within color-value-versus-weight table 241 is also maintained constant.

Accordingly, unlike a conventional dot-count system, the image forming apparatus according to the embodiments is free from the influence of the increase/decrease in the printed dots due to a calibration process (density correction), and allows the toner usage to be obtained at any time.

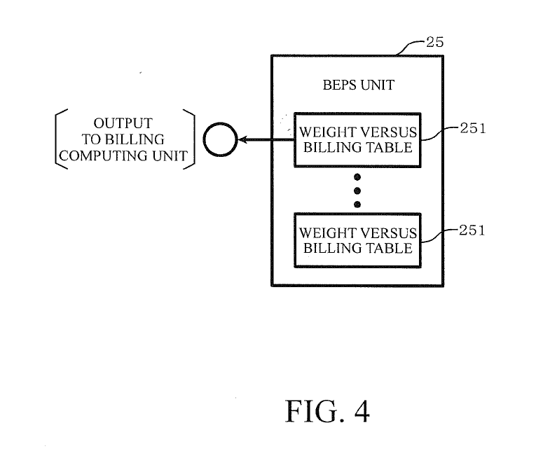

FIG. 4 illustrates a configuration of BEPS unit 25.

As illustrated in FIG. 4, BEPS unit 25 includes weight-versus-billing tables 251. The weight-versus-billing tables 251 each include the charge per unit weight of toner of each of cyan, magenta, yellow, and black as the billing evaluation parameter.

### First Embodiment

In a first embodiment of the present disclosure, an image having a smaller gradation number than the subject image to be printed is generated and is then color-converted, and the toner usage at a time of printing thereof is evaluated based on the color-converted image.

The first embodiment of the present disclosure is described with reference to the accompanying drawings.

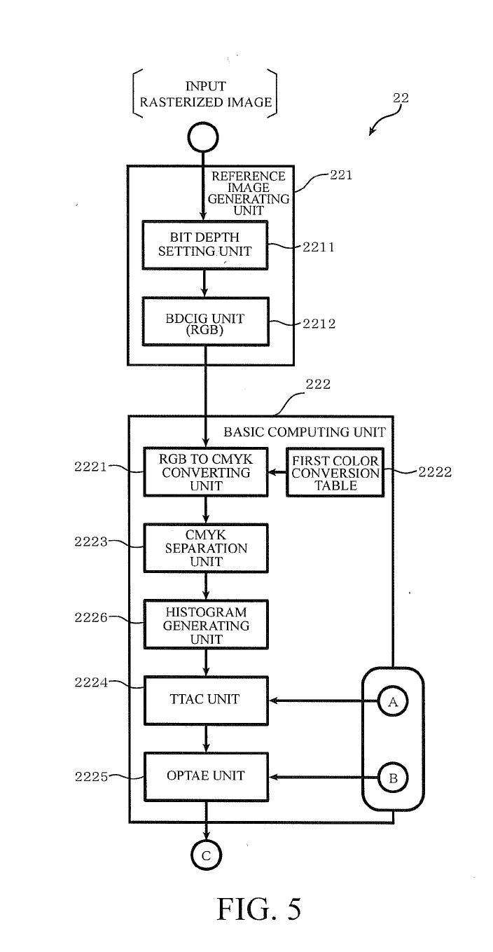

FIG. 5 illustrates a configuration of a toner usage prediction unit according to the first embodiment.

As illustrated in FIG. 5, toner usage prediction unit 22 includes a reference image generating unit 221 and basic computing unit 222.

Reference image generating unit 221 includes bit depth setting unit 2211 and bit-depth-converted image generating (BDCIG) unit 2212.

Bit depth setting unit 2211 sets, as a bit depth, a gradation number smaller than a gradation number of the rasterized image (subject image) output from the image processing unit. The bit depth indicates the gradation number. For example, 5 bits correspond to 32 gradations, 6 bits correspond to 64 gradations, and 7 bits correspond to 128 gradations. The bit depth can be set or changed according to the user's input operation.

BDCIG unit 2212 is located in a stage prior to basic computing unit 222. BDCIG unit 2212 converts the subject image into an image having the gradation number of the set bit depth to thereby generate a bit-depth-converted image (reference image) formed of the RGB components used for the evaluation of the toner usage.

For example, BDCIG unit 2212 divides an entire range of gradation values (color values) of the subject image by threshold values whose number corresponds to the bit depth, and groups the divided range of gradation values into a specific color value for each threshold value, thereby forming an image having a small gradation number.

Specifically, to convert subject image having 256 gradations into an image having a depth of 2 bits (4 gradations), it is possible to set gradation values 0 to 63 as a first threshold value, gradation values 64 to 127 as a second threshold value, gradation values 128 to 191 as a third threshold value, and gradation values 192 to 255 as a fourth threshold value. Based on those settings, BDCIG unit 2212 replaces the color values included in the first threshold value with 0, the color values included in the second threshold value with 86, the color values included in the third threshold value with 170, and the color values included in the fourth threshold value with 255. Thus, the image having 256 gradations is converted into the image (bit-depth-converted image) having 4 gradations.

Note that BDCIG unit 2212 outputs the generated bit-depth-converted image to basic computing unit 222.

Basic computing unit 222 includes, as illustrated in FIG. 5, RGB-to-CMYK converting unit 2221, first color conversion table 2222, CMYK separation unit 2223, transfer toner amount converting (TTAC) unit 2224, on-paper toner amount evaluation (OPTAE) unit 2225, and histogram generating unit 2226.

RGB-to-CMYK converting unit 2221 (color converting unit) executes a color conversion process on the bit-depth-converted image output from reference image generating unit 221. Specifically, RGB-to-CMYK converting unit 2221 references first color conversion table 2222 in which the relationship between the RGB values and the CMYK values is expressed as a grid at regular intervals or irregular intervals to thereby convert the bit-depth-converted image formed of the RGB components into the bit-depth-converted image (color-converted image) formed of the CMYK components.

CMYK separation unit 2223 (separation processing unit) generates separated images of the respective channels by separating the respective pixels of the bit-depth-converted image formed of the CMYK components into the respective channels of C, M, Y, and K.

With this configuration, it is possible to acquire the separated images from the bit-depth-converted image for the different colors of toner used for printing.

Based on the separated images of the respective channels (C, M, Y, and K) separated by CMYK separation unit 2223, histogram generating unit 2226 generates a histogram that indicates a relationship between the color value and the number of pixels for each channel.

The histogram can express the relationship between the color value and the number of pixels for each of the separated images by, for example, setting the color value and the number of pixels as the horizontal axis and the vertical axis, respectively.

Here, histogram generating unit 2226 generates the histogram by using the separated images obtained by performing the color conversion process on the bit-depth-converted image that has been generated by BDCIG unit 2212 to have a smaller gradation number than the gradation number of the image used for actual printing.

For example, if the bit-depth-converted image having a bit depth of 5 bits (32 gradations) is generated from the subject image whose original gradation number is 256 gradations, histogram generating unit 2226 generates the histogram indicating the number of pixels corresponding to 32 gradation values.

In other words, by using the bit-depth-converted image having a small gradation number, it is possible to reduce the time required for histogram generation.

TTAC unit 2224 (toner usage evaluation unit) uses the histograms and the color-value-versus-weight table 241 to obtain the transfer toner weight (from A of FIG. 3 to A of FIG. 5).

Color-value-versus-weight table 241 is a group of information in which the color value and the transfer toner weight per unit area are associated with each other. Further, the above-mentioned histogram is a group of information in which the color value and the number of pixels are associated with each other. Accordingly, TTAC unit 2224 executes an area correction process for matching the unit area based on which color-value-versus-weight table 241 is generated to the area of a unit pixel used for the histogram generation. This is because a pixel resolution varies (for example, 300 dots per inch (dpi) and 600 dpi) even if the transfer toner weight per unit area is obtained by dividing the transfer toner weight of the sample image by the area of the sample image in generating color-value-versus-weight table 241. Images having different pixel resolutions are different in the area per pixel. Therefore, TTAC unit 2224 performs a conversion to obtain a toner adhesion weight corresponding to an area of 1 pixel according to the pixel resolution, and then obtains the transfer toner weight. After that, TTAC unit 2224 obtains a product by multiplying the transfer toner weight per unit area corresponding to the same color value by the area corresponding to the number of pixels to thereby obtain the transfer toner weight on a color value basis. TTAC unit 2224 obtains a total sum of the transfer toner weights corresponding to all the color values for each of the separated images. Thus obtained are the transfer toner weights for the respective colors of C, M, Y, and K.

As described above, the bit-depth-converted image has a small gradation number, and hence the histogram thereof has a simpler structure than the histogram of the image used for the actual printing. Therefore, the evaluation target of the toner usage becomes smaller, and the toner usage can be obtained more quickly.

For example, if 256 gradations are reduced to 32 gradations, the integration target is reduced in volume to 1/8, and it is accordingly possible to speed up the evaluation of the toner usage.

OPTAE unit 2225 multiplies the transfer toner weight obtained by TTAC unit 2224 by transfer efficiency 242 stored in WEPS unit 24 (from B of FIG. 3 to B of FIG. 5).

With this configuration, it is possible to obtain the on-paper toner weight of toner of each color of cyan, magenta, yellow, and black that is estimated to be used for the print image on the paper when printing the rasterized image, that is, the toner usage.

Incidentally, in the first embodiment, the bit-depth-converted image set to have a small bit depth is used for the evaluation of the toner usage, and hence it is also possible to reduce the volume of the relationship between the color value and the transfer toner weight per unit area within color-value-versus-weight table 241.

For example, if the subject image has 256 gradations, the relationship between the color value and the transfer toner weight per unit area is originally necessary for each gradation value of the 256 gradations. However, if the bit-depth-converted image having a bit depth of 5 bits is used for computation of the toner usage, the relationship is necessary for only 32 gradations.

In other words, by using the bit-depth-converted image having a small bit depth and a small gradation number for the evaluation of the toner usage, it is possible to reduce the load on the generation of color-value-versus-weight table 241 and reduce the load on the evaluation of the toner usage.

Next, a billing process according to the first embodiment is described with reference to the accompanying drawings.

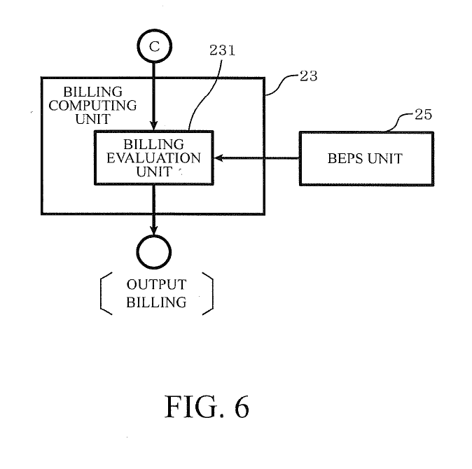

FIG. 6 illustrates a configuration of a billing computing unit according to the first embodiment.

As illustrated in FIG. 6, billing computing unit 23 includes billing evaluation unit 231.

Billing evaluation unit 231 obtains the billing amount for the subject image (from C of FIG. 5 to C of FIG. 6) by multiplying the charge per toner unit weight (within the weight-versus-billing table stored in BEPS unit 25) by the toner usage of the corresponding color and by integrating the resultant, and outputs the obtained the billing amount.

As described above, according to the first embodiment, the bit-depth-converted image having a smaller bit depth and a smaller gradation number than the same subject image as the image data used for the actual printing is generated, and the toner usage obtained based on the bit-depth-converted image is obtained as a toner amount used when the subject image is printed.

Specifically, the usage of toner when the subject image is printed is obtained based on the histogram of the image whose gradation number becomes smaller by reducing the bit depth and on the table in which the color value and the toner weight are associated with each other.

Therefore, it is possible to obtain the toner usage at the time of printing quickly without impairing the image quality of the print image, and further possible to reduce the load on a histogram generation process.

Further, by retaining the histogram, it is possible to immediately use the histogram even when the toner usage is obtained again or used for another purpose.

As described above, according to the first embodiment, the kinds of color values that form the subject image can be reduced. Therefore it is possible to simplify the structure of the corresponding color-value-versus-weight table. Furthermore, the toner usage can be obtained quickly.

Accordingly, the image forming apparatus according to the first embodiment allows the toner usage to be obtained quickly and accurately with a simple structure and configuration.

Further, the billing amount is obtained according to the thus-obtained toner usage, and hence it is possible to present a proper billing amount quickly.

### Second Embodiment

In a second embodiment of the present disclosure, an image having a reduced gradation number is generated after the subject image to be printed is color-converted, and the toner usage at the time of printing is evaluated based on the generated image.

The second embodiment of the present disclosure is described with reference to the accompanying drawings.

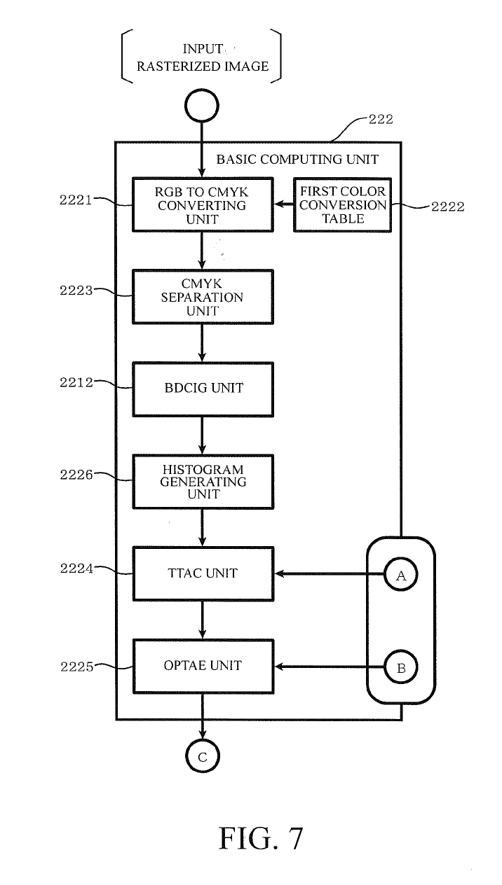

FIG. 7 illustrates a configuration of a toner usage prediction unit according to the second embodiment.

As illustrated in FIG. 7, toner usage prediction unit 22 according to this embodiment is configured as basic computing unit 222 including BDCIG unit 2212, RGB-to-CMYK converting unit 2221, first color conversion table 2222, CMYK separation unit 2223, TTAC unit 2224, OPTAE unit 2225, and histogram generating unit 2226.

RGB-to-CMYK converting unit 2221 (color conversion unit) executes the color conversion process on the rasterized image output from the image processing unit. Specifically, RGB-to-CMYK converting unit 2221 references first color conversion table 2222 in which the relationship between the RGB values and the CMYK values is expressed as a grid at regular intervals or irregular intervals to thereby convert the rasterized image formed of the RGB components into an image formed of the CMYK components.

CMYK separation unit 2223 (separation processing unit) generates the separated image (subject image) for each of C, M, Y, and K by separating the respective pixels of the image formed of the CMYK components into the respective channels of C, M, Y, and K.

BDCIG unit 2212 converts the respective separated images for cyan, magenta, yellow, and black generated by CMYK separation unit 2223 into the bit-depth-converted images having a smaller gradation number than the original gradation number.

Based on the bit-depth-converted images of the respective channels, histogram generating unit 2226 generates a histogram that indicates a relationship between the color value and the number of pixels for each channel.

Therefore, it is possible to reduce the time required for the histogram generation by using the bit-depth-converted image obtained by reducing the gradation numbers of the separated images for cyan, magenta, yellow, and black.

TTAC unit 2224 uses the histograms and color-value-versus-weight table 241 to obtain the transfer toner weight (from A of FIG. 3 to A of FIG. 7).

OPTAE unit 2225 multiplies the transfer toner weight obtained by TTAC unit 2224 by the transfer efficiency stored in WEPS unit 24 (from B of FIG. 3 to B of FIG. 7).

The detailed operations of TTAC unit 2224 and OPTAE unit 2225 are the same as those of the first embodiment.

With this configuration, it is possible to obtain the on-paper toner weight of toner of each color of cyan, magenta, yellow, and black that is estimated to be used for the print image on the paper when printing the rasterized image, that is, the toner usage.

Note that a billing process according to the second embodiment is the same as that of the first embodiment.

As described above, according to the second embodiment, the bit-depth-converted image having a smaller bit depth and a smaller gradation number than the same subject image as the image data used for the actual printing is generated, and the toner usage obtained based on the bit-depth-converted image is obtained as a toner amount used when the subject image is printed.

Specifically, the usage of toner when the subject image is printed is obtained based on the histogram of the image whose gradation number becomes smaller by reducing the bit depth and the table in which the color value and the toner weight are associated with each other.

Therefore, it is possible to obtain the toner usage at the time of printing quickly without impairing the image quality of the print image, and further to reduce the load on a histogram generation process.

Further, by retaining the histogram, it is possible to immediately use the histogram even when the toner usage is obtained again or used for another purpose.

As described above, according to the second embodiment, the kinds of the color values that form the subject image can be reduced. Therefore, it is possible to simplify the structure of the corresponding color-value-versus-weight table. Furthermore, the toner usage can be obtained quickly.

Note that, in the first and second embodiments, the transfer toner weight may be obtained without using the histogram.

That is, the TTAC unit of the basic computing unit may obtain the transfer toner weight of toner used for printing the rasterized image based on the color-value-versus-weight table stored in the WEPS unit.

Specifically, the TTAC unit sequentially reads the color values of the respective pixels in the image of each channel having a reduced bit depth. The TTAC unit extracts the toner weight corresponding to each of the read color values from the color-value-versus-weight table. The TTAC unit accumulates the extracted toner weights to thereby obtain the transfer toner weight necessary to print the rasterized image.

The billing amount is obtained according to the thus-obtained toner usage, and hence it is possible to present a proper billing amount quickly.

### Third Embodiment

In a third embodiment of the present disclosure, an image obtained by reducing the subject image to be printed is generated and is then color-converted, and the toner usage at the time of printing the subject image is evaluated based on the color-converted image.

The third embodiment of the present disclosure is described with reference to the accompanying drawings.

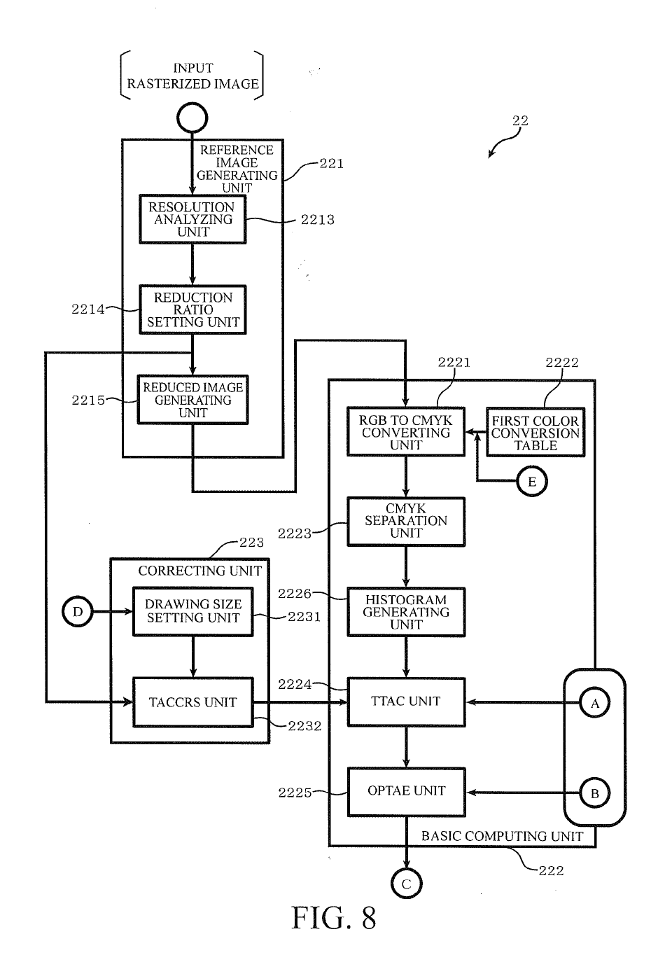

FIG. 8 illustrates a configuration of a toner usage prediction unit according to the third embodiment.

As illustrated in FIG. 8, toner usage prediction unit 22 includes reference image generating unit (thumbnail processing unit) 221, correcting unit 223, and basic computing unit 222.

Reference image generating unit 221 includes resolution analyzing unit 2213, reduction ratio setting unit 2214, and reduced image generating unit 2215.

Reference image generating unit 221 analyzes a size and a resolution of the rasterized image (subject image) output from the image processing unit.

In more details, resolution analyzing unit 2213 extracts the size of the rasterized image and the number of dots per unit area (dpi) thereof.

Reduction ratio setting unit 2214 sets reduction ratio β used for generating a thumbnail image. For example, reduction ratio setting unit 2214 can set a homothetic ratio of the thumbnail image to the rasterized image as reduction ratio β. Further, reduction ratio setting unit 2214 may set reduction ratio β to a reduction ratio preset at the time of manufacturing or shipping of image forming apparatus 1 or a reduction ratio set/changed by the user through an operating unit. Reduction ratio setting unit 2214 outputs the set reduction ratio β to reduced image generating unit 2215 and to correcting unit 223.

Reduced image generating unit 2215 generates the thumbnail image (reduced image) according to reduction ratio β. For example, reduced image generating unit 2215 generates the thumbnail image (reference image) obtained by reducing the size of the rasterized image by reduction ratio β, and outputs the resultant to basic computing unit 222.

At this time, the thumbnail image is generated having a number of pixels that is 1/β² of the rasterized image (if the reduction ratio β is a homothetic ratio).

Accordingly, in a case where, for example, an A10-size thumbnail image is generated from an A4-size rasterized image formed of 10,000 pixels, the number of pixels of the generated thumbnail image is approximately 156 pixels.

Correcting unit 223 includes, as illustrated in FIG. 8, drawing size setting unit 2231 and toner amount conversion correction rate setting (TACCRS) unit 2232.

Drawing size setting unit 2231 sets a drawing size in a case where printing is desired with a different drawing size from a drawing size of the rasterized image. For example, drawing size setting unit 2231 sets the drawing size (for example, A6) used for the actual printing according to the user's input operation.

Here, if the A4-size rasterized image is set to have an A6 drawing size when printing, drawing size setting unit 2231 notifies the image processing unit and TACCRS unit 2232 of its reduction ratio α (=1/2).

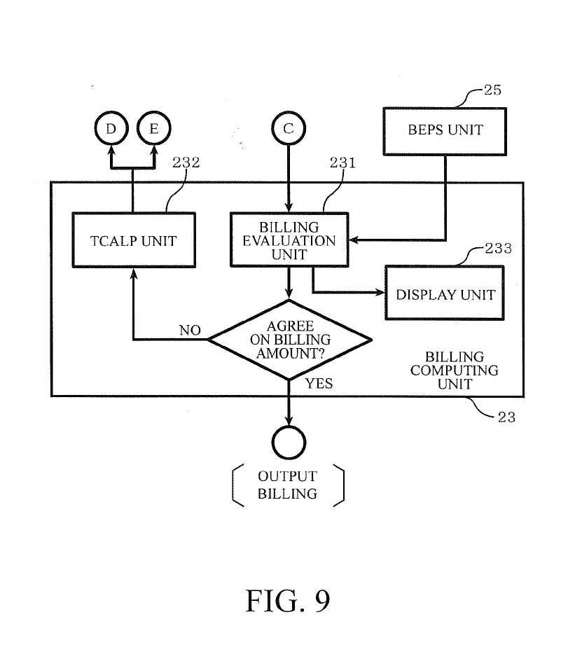

Note that, when a notification is received from toner consumption amount lowering processing (TCALP) unit 232 described later, drawing size setting unit 2231 can also set the preset drawing size smaller than the current drawing size (from D of FIG. 9 to D of FIG. 8).

TACCRS unit 2232 obtains correction rate γ used for converting the transfer toner weight based on the drawing size set by drawing size setting unit 2231.

Specifically, if reduction ratio α is set in drawing size setting unit 2231 and reduction ratio β of the thumbnail image is set, TACCRS unit 2232 obtains the correction rate γ used for converting the toner amount of the print image based on the following expression (1).

γ=(α/β)² (1)

Further, the correction rate γ can also be obtained by actually measuring the drawing size of the same rasterized image with reduction ratios α and β in advance, obtaining a difference between the conversion value and the actually measured value, and substituting the resultant into the following expression (2).

γ=(C1·α+C2)/(C3·β+C4)+C5 (2)

(In the expression, C1 to C5 represent correction coefficients.)

Correction rate γ that has been set is output to TTAC unit 2224 (described later) of basic computing unit 222.

Basic computing unit 222 includes, as illustrated in FIG. 8, RGB-to-CMYK converting unit 2221, first color conversion table 2222, CMYK separation unit 2223, TTAC unit 2224, OPTAE unit 2225, and histogram generating unit 2226.

RGB-to-CMYK converting unit 2221 (color conversion unit) executes a color conversion process on the thumbnail image output from reference image generating unit 221. Specifically, RGB-to-CMYK converting unit 2221 references first color conversion table 2222 in which the relationship between the RGB values and the CMYK values is expressed as a grid at regular intervals or irregular intervals to thereby convert the thumbnail image formed of the RGB components into the thumbnail image (color-converted image) formed of the CMYK components.

CMYK separation unit 2223 (separation processing unit) acquires separated images of the respective channels by separating the respective pixels of the thumbnail image formed of the CMYK components into the respective channels of C, M, Y, and K.

With this configuration, it is possible to acquire the separated images from the thumbnail image for the different colors of toner used for printing.

Based on the separated images of the respective channels (C, M, Y, and K) separated by CMYK separation unit 2223, histogram generating unit 2226 generates a histogram that indicates the relationship between the color value and the number of pixels for each channel.

The histogram can express the relationship between the color value and the number of pixels for each of the separated images by, for example, setting the color value and the number of pixels as the horizontal axis and the vertical axis, respectively.

Here, histogram generating unit 2226 generates the histogram by using the separated images obtained by performing the color conversion process on the thumbnail image that has been generated by reduced image generating unit 2215 reducing the image used for actual printing. By using the thumbnail image, it is possible to reduce the time required for the histogram generation.

TTAC unit 2224 (thumbnail toner usage evaluation unit) uses the histograms and color-value-versus-weight table 241 to obtain the transfer toner weight (thumbnail toner usage) of the thumbnail image (from A of FIG. 3 to A of FIG. 8).

That is, color-value-versus-weight table 241 is a group of information in which the color value and the transfer toner weight per unit area are associated with each other. Further, the above-mentioned histogram is a group of information in which the color value and the number of pixels are associated with each other. Accordingly, TTAC unit 2224 executes the area correction process for matching the unit area based on which color-value-versus-weight table 241 is generated to the area of a unit pixel used for the histogram generation. This is because the pixel resolution varies (for example, 300 dpi and 600 dpi) even if the transfer toner weight per unit area is obtained by dividing the transfer toner weight of the sample image by the area of the sample image in generating color-value-versus-weight table 241. Images having different pixel resolutions are different in the area per pixel. Therefore, TTAC unit 2224 performs a conversion to obtain the toner adhesion weight corresponding to an area of 1 pixel according to the pixel resolution, and then obtains the transfer toner weight. After that, TTAC unit 2224 obtains a product by multiplying the transfer toner weight per unit area corresponding to the same color value by the area corresponding to the number of pixels to thereby obtain the transfer toner weight on a color value basis. TTAC unit 2224 obtains the total sum of the transfer toner weights corresponding to all the color values for each of the separated images. It is thus possible to obtain the transfer toner weights for the respective colors of C, M, Y, and K.

Subsequently, TTAC unit 2224 (print image toner usage evaluation unit) multiplies the obtained transfer toner weight by correction rate γ input from TACCRS unit 2232 of correcting unit 223. The transfer toner weight of toner used when the rasterized image is printed with the set drawing size (print image) is thus obtained.

OPTAE unit 2225 multiplies the transfer toner weight of the print image obtained by TTAC unit 2224 by transfer efficiency 242 stored in WEPS unit 24 (from B of FIG. 3 to B of FIG. 8).

With this configuration, it is possible to obtain the on-paper toner weight of toner of each color of cyan, magenta, yellow, and black that is estimated to be used for the print image on the paper when actually printing the subject image, that is, the toner usage.

Next, a billing process according to the third embodiment is described with reference to the accompanying drawings.

FIG. 9 illustrates a configuration of the billing computing unit according to the third embodiment.

As illustrated in FIG. 9, billing computing unit 23 includes billing evaluation unit 231, TCALP unit 232, and display unit 233.

Billing evaluation unit 231 obtains the billing amount for the subject image (from C of FIG. 8 to C of FIG. 9) by multiplying the charge per toner unit weight within weight-versus-billing table 251 stored in BEPS unit 25 by the toner usage of the color value corresponding thereto and integrating the resultant.

Display unit 233 displays the obtained billing amount.

For example, if the user performs an operation for agreeing on the obtained billing amount, the billing amount is output and stored in a storage medium or displayed by display unit 233.

In contrast, if the user performs an operation for disagreeing on the obtained billing amount, TCALP unit 232 performs a process for lowering a toner consumption amount.

For example, when performing printing control for a change to a smaller size than the current drawing size, TCALP unit 232 outputs a notification that the size is to be changed to drawing size setting unit 2231 (from D of FIG. 9 to D of FIG. 8).

When receiving the notification, drawing size setting unit 2231 sets the drawing size smaller than the currently-set drawing size. Basic computing unit 222 (scale image toner usage evaluation unit) obtains the toner usage of the image having a drawing size set based on the correction rate γ (that is, a change rate of the drawing size) corresponding to the newly-set drawing size.

Further, when performing printing control for a change to a lighter color than the current density, TCALP unit 232 outputs a notification that the density is to be changed to RGB-to-CMYK converting unit 2221 (from E of FIG. 9 to E of FIG. 8). RGB-to-CMYK converting unit 2221 that has received the notification changes a color conversion coefficient of first color conversion table 2222 so as to output a lighter density. Then, basic computing unit 222 obtains the toner usage of the rasterized image based on the color value color-converted according to the changed color conversion coefficient.

As described above, according to the image forming apparatus of the third embodiment, a reduced image is temporarily generated at a specific reduction ratio, and a reverse operation value of the reduction ratio to the toner usage of the reduced image is used to obtain the toner amount used when the rasterized image is printed.

Therefore, it is possible to obtain the toner usage at the time of printing quickly without impairing the image quality of the print image, and further possible to reduce the load on the histogram generation process.

Further, by retaining the histogram, it is possible to immediately use the histogram even when the toner usage is obtained again or used for another purpose.

Further, when printing with a drawing size different from the rasterized image, a specific correction rate is multiplied to thereby obtain the toner amount at high speed.

As described above, according to the third embodiment, the kinds of the color values that form the subject image can be reduced. Therefore it is possible to simplify the structure of the corresponding color-value-versus-weight table. Furthermore, the toner usage can be obtained quickly.

Accordingly, the image forming apparatus according to the third embodiment allows the toner usage to be obtained quickly and accurately with a simple structure and configuration.

Further, the billing amount is obtained according to the thus-obtained toner usage, and hence it is possible to present a proper billing amount quickly.

Note that, in the third embodiment, the toner usage may be obtained without using the histogram.

That is, the TTAC unit of the basic computing unit may obtain the transfer toner weight of toner used for printing the rasterized image based on the weight evaluation parameter stored in the WEPS unit.

Specifically, the TTAC unit uses the color-value-versus-weight table to obtain the transfer toner weight corresponding to the color value of each pixel of the thumbnail image, and multiplies the transfer toner weight by the correction rate γ.

For example, the TTAC unit sequentially reads the color values given to the respective pixels in the separated image for cyan of the thumbnail image. The TTAC unit extracts the transfer toner weight corresponding to each of the read color values from the color-value-versus-weight table for cyan. The TTAC unit accumulates the extracted toner weights to thereby obtain the transfer toner weight for cyan of the thumbnail image. The TTAC unit executes the same process on the separated images for magenta, yellow, and black of the thumbnail image to thereby obtain the transfer toner weights for magenta, yellow, and black.

Subsequently, the TTAC unit multiplies the obtained transfer toner weight by the correction rate γ acquired from the TACCRS unit of the correcting unit to thereby obtain the transfer toner weight of toner used when the rasterized image is printed with the set drawing size.

The billing amount is obtained according to the thus-obtained toner usage, and hence it is possible to present a proper billing amount quickly.

### Fourth Embodiment

In a fourth embodiment of the present disclosure, when the toner usage at the time of printing the subject image is evaluated, the reference image used for the evaluation is decomposed into a high-frequency image and a low-frequency image, and the values evaluated with respect to the respective images are totalized.

The fourth embodiment of the present disclosure is described with reference to the accompanying drawings.

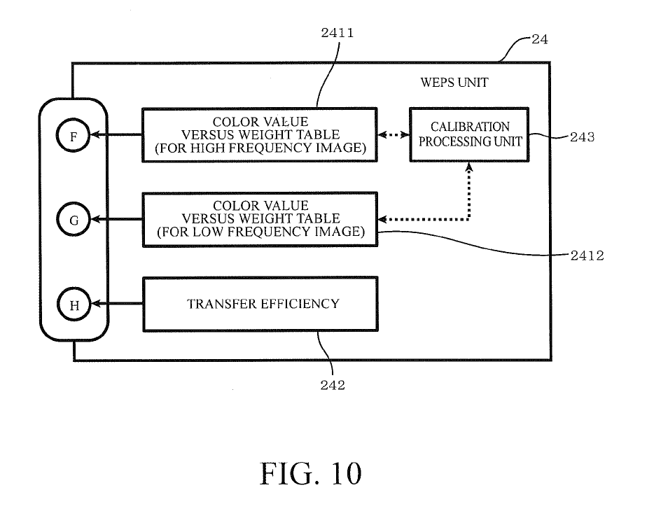

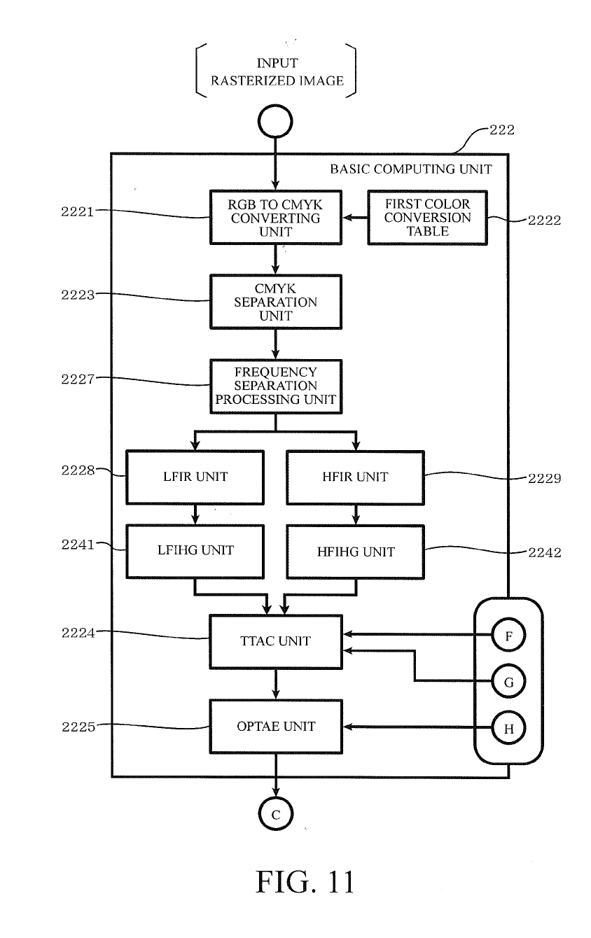

In the fourth embodiment, the WEPS unit 24 illustrated in FIG. 10 is used in place of that of FIG. 3. Further, the basic computing unit 222 of FIG. 11 is used in place of that of FIG. 5 or FIG. 8. Components other than the basic computing unit 222 of the toner usage prediction unit are the same as those of the first embodiment or the third embodiment.

As illustrated in FIG. 10, WEPS unit 24 includes color-value-versus-weight table (for a high-frequency image) 2411, color-value-versus-weight table (for a low-frequency image) 2412, transfer efficiency 242, and calibration processing unit 243.

Color-value-versus-weight table (for a high-frequency image) 2411 and color-value-versus-weight table (for a low-frequency image) 2412 include the relationship between the color value and the transfer toner weight per unit area as the weight evaluation parameter. Color-value-versus-weight table (for a high-frequency image) 2411 and color-value-versus-weight table (for a low-frequency image) 2412 can be generated based on actually measured values of toner weights. For example, in a case of color-value-versus-weight table (for a high-frequency image) 2411, some color values are selected at specific color value intervals. A sample image formed of each of the selected color values that has a dot width of 1 to 2 dots and forms an edge area such as a line or a character, is output (drawn), and the weight of the toner adhering to the transferring belt is measured as the transfer toner weight. Further, in a case of color-value-versus-weight table (for a low-frequency image) 2412, the sample image such as a square or a circle that forms a smooth area based on dithering is output (drawn), and the weight of the toner adhering to the transferring belt is measured as the transfer toner weight. The weight of the adhering toner can be actually measured with a scale after collecting the adhering toner.

By dividing the measured transfer toner weights by the area of the sample image, the transfer toner weights per unit area can be obtained for the high-frequency image and the low-frequency image for each of cyan, magenta, yellow, and black on a color value basis. Then, by associating the obtained toner weights per unit area with the color value corresponding thereto, color-value-versus-weight table (for a high-frequency image) 2411 and color-value-versus-weight table (for a low-frequency image) 2412 can be generated.

Transfer efficiency 242 indicates a ratio at which the toner adhering to the transferring belt is printed on the paper. By multiplying the transfer toner weight by transfer efficiency 242, the toner amount printed on the paper can be obtained.

Note that, in creating color-value-versus-weight table (for a high-frequency image) 2411 and color-value-versus-weight table (for a low-frequency image) 2412, the weight of the paper before printing (to which toner has not adhered yet) is previously obtained, the weight of the paper after printing the above-mentioned sample image is measured, and the difference therebetween can be set as the transfer toner weight. In this case, the transfer toner weight has the same value as the on-paper toner weight. That is, there is no need to multiply the transfer toner weight by transfer efficiency 242 in order to obtain the on-paper toner weight.

Calibration processing unit 243 executes the calibration each time the printing process is performed for a predetermined period of time or for a predetermined number of sheets.

The calibration is the process for executing the correction of the input/output characteristic (gamma correction) so that the density (or brightness) of the image output according to the input of a given color value is kept constant even under the influence of an environmental change, a change over time, or the like. Specifically, the printed dots are increased or decreased so as to obtain a constant input/output characteristic (for example, a curved shape of a gamma curve).

In other words, the print density corresponding to a given color value is constant, and the toner weight corresponding to the color value is also maintained at substantially the same value. Therefore, if the calibration functions effectively, the relationship between the color value and the toner weight per unit area within color-value-versus-weight table (for a high-frequency image) 2411 and color-value-versus-weight table (for a low-frequency image) 2412 is also maintained constant.

Accordingly, unlike the conventional dot-count system, the image forming apparatus according to the fourth embodiment is free from the influence of the increase/decrease in the printed dots due to the calibration process (density correction), and allows the toner usage to be obtained at any time.

FIG. 11 illustrates a configuration of the basic computing unit according to the fourth embodiment.

As illustrated in FIG. 11, basic computing unit 222 includes RGB-to-CMYK converting unit 2221, first color conversion table 2222, CMYK separation unit 2223, TTAC unit 2224, OPTAE unit 2225, frequency separation processing unit 2227, low-frequency image retaining (LFIR) unit 2228, high-frequency image retaining (HFIR) unit 2229, low-frequency image histogram generating (LFIHG) unit 2241, and high-frequency image histogram generating (HFIHG) unit 2242.

RGB-to-CMYK converting unit 2221 (color conversion unit) executes the color conversion process on the reference image (bit-depth-converted image or thumbnail image) output from reference image generating unit 221. Specifically, RGB-to-CMYK converting unit 2221 references first color conversion table 2222 in which the relationship between the RGB values and the CMYK values is expressed as a grid at regular intervals or irregular intervals to thereby convert the reference image formed of the RGB components into the color-converted image formed of the CMYK components.

CMYK separation unit 2223 (separation processing unit) generates the separated images (subject images) of the respective channels by separating the respective pixels of the color-converted image of the CMYK components into the respective channels of C, M, Y, and K.

With this configuration, it is possible to acquire the separated images from the color-converted image for the different colors of toner used for printing.

Frequency separation processing unit 2227 separates the separated images into the high-frequency image and the low-frequency image based on a specific frequency element.

Here, the frequency element is defined by taking a spatial frequency in which the density value of a pixel changes depending on its position as a reference, and a portion that exceeds a specific level of a density change can be set as the high-frequency image while the other portion can be set as the low-frequency image. For example, in a case where a spatial region (x,y) of the subject image is converted into a frequency region (u,v), a region that satisfies u<μ and v<ν can be determined as the high-frequency image, and the other region can be determined as the low-frequency image. It is possible to set arbitrary frequencies as μ and ν.

Note that, in a case of an electrophotographic process, more toner adheres to a line, a character, and an end portion of a graphic (hereinafter, referred to as “edge area”) due to an edge effect than to the smooth area other than the edge area, and hence the edge area exhibits a large change in the density value, thereby exemplifying the high-frequency image.

As described above, the frequency separation processing unit 2227 can separate, from the subject image, the image of the edge area as the high-frequency image and the image of the smooth area as the low-frequency image. For example, the separation between the high-frequency image and the low-frequency image can be facilitated by extracting the edge area by using a known edge extraction program.

Note that the separated low-frequency image is retained in LFIR unit 2228, and the high-frequency image is retained in HFIR unit 2229.

Based on the separated images of the low-frequency image and the high-frequency image of the respective channels, LFIHG unit 2241 and HFIHG unit 2242 generate the histograms indicating the relationship between the color value and the number of pixels with regard to the high-frequency image and the low-frequency image, respectively, for each channel.

The histogram can express the correlation between the color value and the number of pixels for each of the separated images by, for example, setting the color value and the number of pixels as the horizontal axis and the vertical axis, respectively.

TTAC unit 2224 (toner usage evaluation unit) uses those respective histograms and color-value-versus-weight table (for a high-frequency image) 2411 to obtain the transfer toner weight of toner used when the high-frequency image is printed (from F of FIG. 10 to F of FIG. 11).

Further, TTAC unit 2224 uses those respective histograms and color-value-versus-weight table (for a low-frequency image) 2412 to obtain the transfer toner weight of toner used when the low-frequency image is printed (from G of FIG. 10 to G of FIG. 11).

Color-value-versus-weight table (for a high-frequency image) 2411 and color-value-versus-weight table (for a low-frequency image) 2412 are each a group of information in which the color value and the transfer toner weight per unit area are associated with each other. Further, a high-frequency image histogram and a low-frequency image histogram are each a group of information in which the color value and the number of pixels are associated with each other. Accordingly, TTAC unit 2224 executes the area correction process for matching the unit area based on which color-value-versus-weight table (for a high-frequency image) 2411 and color-value-versus-weight table (for a low-frequency image) 2412 are generated to the area of a unit pixel used for the histogram generation. This is because the pixel resolution varies (for example, 300 dpi and 600 dpi) even if the transfer toner weight per unit area is obtained by dividing the transfer toner weight of the sample image by the area of the sample image in generating color-value-versus-weight table (for a high-frequency image) 2411 and color-value-versus-weight table (for a low-frequency image) 2412. Images having different pixel resolutions are different in the area per pixel. Therefore, TTAC unit 2224 performs a conversion to obtain the toner adhesion weight corresponding to an area of 1 pixel according to the pixel resolution, and then obtains the transfer toner weight. After that, TTAC unit 2224 obtains a product by multiplying the transfer toner weight per unit area corresponding to the same color value by the area corresponding to the number of pixels to thereby obtain the transfer toner weight on a color value basis. TTAC unit 2224 obtains the total sum of the transfer toner weights corresponding to all the color values for each of the separated images. It is thus possible to obtain the transfer toner weight of toner used for printing the high-frequency image and the transfer toner weight of toner used for printing the low-frequency image.

Note that if the reference image is the thumbnail image, TTAC unit 2224 multiplies the obtained transfer toner weight by the correction rate γ input from the TACCRS unit of the correcting unit.

OPTAE unit 2225 multiplies the respective transfer toner weights obtained by TTAC unit 2224 separately for the high-frequency image and the low-frequency image by transfer efficiency 242 illustrated in FIG. 10 (from H of FIG. 10 to H of FIG. 11), and totalizes the resultant.

With this configuration, it is possible to obtain the on-paper toner weight (the toner usage) of toner of each color of cyan, magenta, yellow, and black that is estimated to be used for the print image on the paper when printing the rasterized image.

Note that, in the fourth embodiment, the toner usage may be obtained without using the histogram in the same manner as in the first to third embodiments.

As described above, according to the image forming apparatus of the fourth embodiment, the subject image is separated into the high-frequency image and the low-frequency image, the toner usage of the high-frequency image is obtained based on the color value of the high-frequency image while the toner usage of the low-frequency image is obtained based on the color value of the low-frequency image.

According to the fourth embodiment, the accuracy of the evaluation can be enhanced by evaluating the toner usage in consideration of the influence of the edge effect.

Accordingly, according to the fourth embodiment, it is possible to obtain the toner usage quickly and accurately.

### Fifth Embodiment

In a fifth embodiment of the present disclosure, a second color conversion table for a draft mode is used in place of the first color conversion table according to the first, third, or fourth embodiment to evaluate the toner usage in a case where the draft mode is selected.

The fifth embodiment of the present disclosure is described with reference to the accompanying drawings.

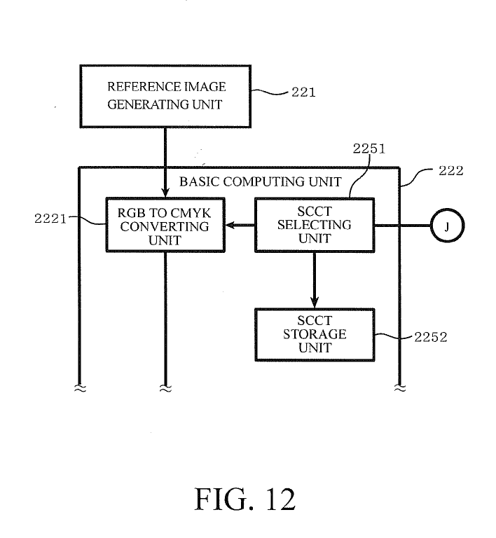

FIG. 12 illustrates a configuration of a portion of the basic computing unit according to the fifth embodiment. As illustrated in FIG. 12, basic computing unit 222 includes second color conversion table (SCCT) selecting unit 2251 and second color conversion table (SCCT) storage unit 2252.

SCCT selecting unit 2251 selects one second color conversion table from among a plurality of color conversion tables (hereinafter referred to as “second color conversion tables”) that have different density setting rates and are stored in SCCT storage unit 2252.

Therefore, the user can change the first color conversion table to an arbitrary second color conversion table, and can further change the second color conversion table that has been temporarily selected to another second color conversion table.

Further, SCCT selecting unit 2251 according to this embodiment performs an operation for selecting the second color conversion table corresponding to a request received from a toner consumption amount setting (TCAS) unit described later.

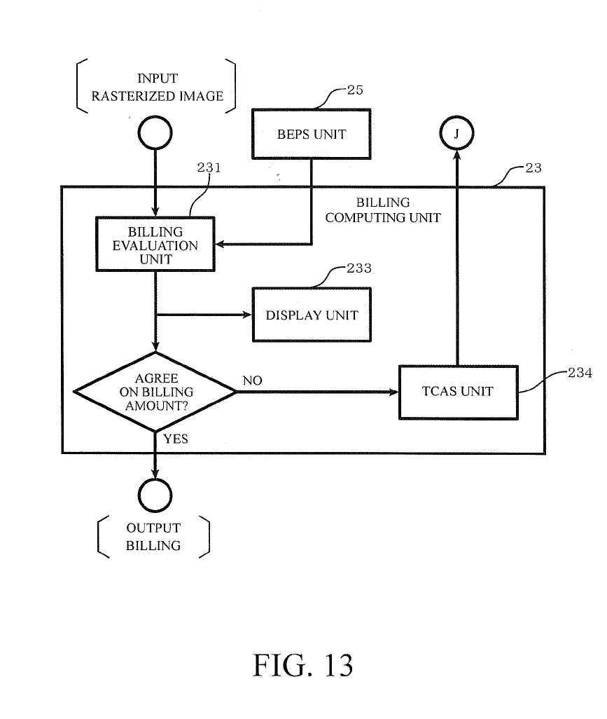

Specifically, as illustrated in FIG. 13, billing computing unit 23 includes billing evaluation unit 231, display unit 233, and toner consumption amount setting (TCAS) unit 234.

Billing evaluation unit 231 obtains the billing amount for the subject image by multiplying the charge per toner unit weight within the weight-versus-billing table stored in BEPS unit 25 by the toner usage of the color value corresponding thereto, and integrating the resultant.

Display unit 233 displays the obtained billing amount.

For example, if the user performs the operation for agreeing on the obtained billing amount, the billing amount is output and stored in the storage medium or displayed by display unit 233.

In contrast, if the user performs the operation for disagreeing on the obtained billing amount, TCAS unit 234 sets the density setting rate so as to exhibit a lighter color than the currently-set density setting rate of the color conversion table (first color conversion table or second color conversion table), and notifies SCCT selecting unit 2251 of the density setting rate (from J of FIG. 13 to J of FIG. 12).

SCCT selecting unit 2251 that has been notified of the density setting rate extracts the second color conversion table corresponding to the received density setting rate from SCCT storage unit 2252, and replaces the current color conversion table with the extracted second color conversion table.

Then, in the same manner as in the first, third, or fourth embodiment, basic computing unit 222 obtains the toner usage based on the respective color values of the image color-converted via the new second color conversion table after the change.

As described above, according to the image forming apparatus of the fifth embodiment, the toner usage and the billing amount in a case where color printing is executed are obtained by using the image converted via the second color conversion table.

Therefore, it is possible to obtain the toner usage and the billing amount quickly also at the time of draft mode printing.

### Sixth Embodiment

In a sixth embodiment of the present disclosure, the reference image obtained by lightening the color of the subject image to be printed is used to evaluate the toner usage in the case where the draft mode is selected.

The sixth embodiment of the present disclosure is described with reference to the accompanying drawings.

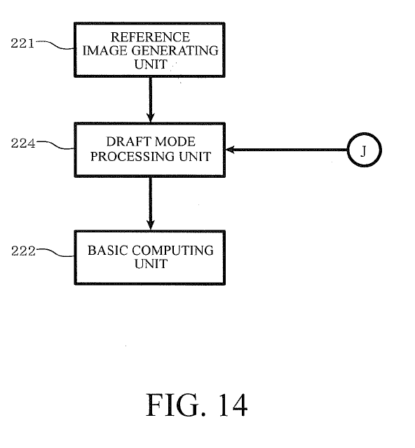

FIG. 14 illustrates a draft mode processing unit according to the sixth embodiment of the present disclosure.

As illustrated in FIG. 14, draft mode processing unit 224 is provided in a stage prior to basic computing unit 222.

That is, in the sixth embodiment, a process involved in the lightening in the draft mode is executed in a step prior to the color conversion process.

Draft mode processing unit 224 executes a modification on the reference image output from reference image generating unit 221. Specifically, draft mode processing unit 224 modifies input color values of the RGB components so as to be able to obtain output color values of the CMYK components exhibiting a lighter color than the normal print density via the first color conversion table.

Specifically, the computation process based on the following expression (3) is executed on the RGB values of each of the pixels that form the reference image.

(r′,g′,b′)=(255,255,255)−{(255,255,255)−ρ(r,g,b)} (3)

(In the expression, (r,g,b) represents the RGB values before the modification, (r′,g′,b′) represents the RGB values after the modification, the gradation number is set to 256 gradations, and the density setting rate assumes ρ (0≦ρ≦1).)

The draft mode processing unit outputs the color values (r′,g′,b′) acquired by the above-mentioned modification process to basic computing unit 222. Then, basic computing unit 222 executes the color conversion process by using the first color conversion table, and then obtains the toner usage in the same manner as in the first, third, or fourth embodiment.

With this configuration, it is possible to obtain the toner usage necessary at the time of the draft mode printing.

Further, in the same manner as in the fifth embodiment, the billing amount at the time of the draft mode printing is obtained based on the obtained toner usage.

Note that, as illustrated in FIG. 13, if the user disagrees on the billing amount obtained by billing evaluation unit 231, TCAS unit 234 sets the density setting rate so as to output a lighter color than the currently-set density setting rate, and notifies draft mode processing unit 224 of the density setting rate (from J of FIG. 13 to J of FIG. 14).

Subsequently, draft mode processing unit 224 that has been notified of the density setting rate executes an image modification process based on the above-mentioned expression (3) using the density setting rate.

As described above, according to the image forming apparatus of the sixth embodiment, the toner usage and the billing amount at the time of the draft mode printing are obtained by using the reference image.

Therefore, according to the sixth embodiment, printing can be executed in the draft mode without affecting the output characteristic, and it is also possible to obtain the toner usage and the billing amount in that mode accurately and quickly.

The image forming apparatuses according to the embodiments of the present disclosure have been described above, but the present disclosure is not limited to the image forming apparatuses according to the above-mentioned respective embodiments, and various changes may naturally be carried out within the scope of the present disclosure.

For example, the first color conversion table may be obtained based on the color conversion table in which the relationship between the RGB values and the CMYK values is expressed as a grid at regular intervals or irregular intervals, in which black (K) is associated with the RGB values expressing an achromatic color.

In this case, the RGB-to-CMYK converting unit (single black replacing unit) color-converts a pixel whose RGB color components have the same color values as one another into black (K) as an achromatic color component. Alternatively, the RGB-to-CMYK converting unit may obtain the smallest color value among the respective RGB color components of each pixel, and color-convert the smallest value into black (K) as the achromatic color component. At this time, the color values obtained by subtracting the smallest value from the respective RGB values are color-converted into cyan (C), magenta (M), and yellow (Y) excluding black (K). With this configuration, it is possible to obtain the achromatic color component of each pixel as a single black toner amount.

Note that the color conversion may be performed by using one first color conversion table selected from at least two first color conversion tables having different black (K) conversion rates. In this case, the RGB-to-CMYK converting unit color-converts, into black (K), the value obtained by multiplying the RGB values of the achromatic color component of each pixel by the black (K) conversion rate.

Further, after the CMYK separation, the smallest color value may be obtained among the respective CMY color components of each pixel of the image, and the single black toner amount may be obtained based on CMY values obtained by multiplying the smallest value by a specific single black replacement ratio. At this time, the respective usages of cyan toner, magenta toner, and yellow toner can be obtained based on values obtained by subtracting the CMY values after the multiplication of the single black replacement ratio from the CMY values of each pixel.

Further, in a case where a color value to be input does not exist in the color-value-versus-weight table, the first color conversion table, or the second color conversion table, the computation process using interpolation or the like may be executed to obtain a transferred toner amount or the CMYK values as output values.

Further, in the respective embodiments, the color-value-versus-weight table is used to obtain the toner usage, but the toner weight may be obtained based on a mathematical expression or a simulator that corresponds to the relationship between the color value and the toner weight.

Further, the above-mentioned respective embodiments are described by taking a printer as an example, but the present disclosure may be applied widely to general image forming apparatuses including a copier and a multifunction peripheral having a copying function and a printing function.

It should be understood that various changes and modifications to the embodiments presently described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. An image forming apparatus, comprising:
a reference image generating unit configured to convert a subject image into a reference image having a data amount smaller than the subject image; and
a toner usage evaluation unit configured to obtain a usage of toner for printing the subject image based on the reference image.

2. The image forming apparatus according to claim 1, further comprising a color converting unit configured to color-convert the reference image, to generate a color-converted image, via a first color conversion table relating an input color value with an output color value.

3. The image forming apparatus according to claim 2, further comprising:
a separation processing unit configured to form at least one separated image by dividing the color-converted image into a specific number of colors; and
a histogram generating unit configured to generate, for each of the at least one separated image, a histogram relating a color value with a number of pixels,
wherein the toner usage evaluation unit is further configured to obtain the usage of the toner for printing the subject image based on the histogram.

4. The image forming apparatus according to claim 2, further comprising a second color conversion table storage unit configured to store a second color conversion table, in which the output color value corresponding to the input color value is set to a value exhibiting a density lower than the density corresponding to the output color value within the first color conversion table,
wherein the color converting unit is further configured to color-convert the reference image via the second color conversion table.

5. The image forming apparatus according to claim 4, wherein:
the second color conversion table storage unit is further configured to store a plurality of the second color conversion tables, in each of which the output color value corresponding to the input color value is set to the value exhibiting the density lower than the density corresponding to the output color value within the first color conversion table and mutually different densities are set; and
the color converting unit is further configured to color-convert the reference image via a selected one of the plurality of the second color conversion tables.

6. The image forming apparatus according to claim 2, further comprising a draft mode processing unit configured to change a color value of the reference image so that the output color value corresponding to the input color value is set to a value exhibiting a density lower than the density corresponding to the output color value within the first color conversion table.

7. The image forming apparatus according to claim 1, further comprising a bit depth setting unit configured to set a gradation number smaller than a gradation number of the subject image, as a bit depth, wherein:
the reference image generating unit includes a bit-depth-converted image generating unit configured to convert the subject image into a bit-depth-converted image serving as the reference image having the gradation number corresponding to the bit depth; and
the toner usage evaluation unit is further configured to obtain the usage of the toner for printing the subject image based on the bit-depth-converted image.

8. The image forming apparatus according to claim 7, wherein the toner usage evaluation unit is further configured to obtain the usage of the toner for printing the subject image based on color values of the bit-depth-converted image and a relationship between each of the color values and a toner amount used per unit area.

9. The image forming apparatus according to claim 1, wherein:
the reference image generating unit includes a reduced image generating unit configured to generate a reduced image by reducing the subject image by a specific reduction ratio; and
the toner usage evaluation unit includes:
a thumbnail toner usage evaluation unit configured to obtain a toner usage estimated on assumption that the reduced image is printed, as a thumbnail toner usage; and
a print image toner usage evaluation unit configured to obtain the usage of the toner for printing the subject image based on the thumbnail toner usage and the specific reduction ratio.

10. The image forming apparatus according to claim 9, wherein the thumbnail toner usage evaluation unit is further configured to obtain the thumbnail toner usage based on color values of the reduced image and a relationship between each of the color values and a toner amount used per unit area.

11. The image forming apparatus according to claim 9, further comprising:
a drawing size setting unit configured to set a print image size used for printing the subject image; and
a correction rate setting unit configured to obtain a correction rate based on the print image size, a size of the subject image, and the specific reduction ratio of the subject image,
wherein the print image toner usage evaluation unit is further configured to use the thumbnail toner usage and the correction rate to obtain a usage of toner for printing an image sized based on the print image size.

12. The image forming apparatus according to claim 1, further comprising a frequency separation processing unit configured to separate the reference image into a plurality of images based on a specific frequency element,
wherein the toner usage evaluation unit is further configured to obtain the usage of the toner for printing the subject image based on color values of each of the plurality of images obtained by separating the reference image and a relationship between each of the color values for each frequency element and a toner amount used per unit area.

13. The image forming apparatus according to claim 12, wherein:
the frequency separation processing unit is further configured to separate the reference image into a high-frequency image and a low-frequency image based on the specific frequency element; and
the toner usage evaluation unit is further configured to:
obtain a toner usage regarding the high-frequency image based on color values of the high-frequency image and a relationship between each of the color values related to a high-frequency element and the toner amount used per unit area; and
obtain a toner usage regarding the low-frequency image based on color values of the low-frequency image and a relationship between each of the color values related to a low-frequency element and the toner amount used per unit area.

14. The image forming apparatus according to claim 13, further comprising:
a color conversion unit configured to generate a color-converted image by color-converting the reference image via a first color conversion table relating an input color value with an output color value;
a separation processing unit configured to form at least one separated image by dividing the color-converted image into a specific number of colors; and
a histogram generating unit configured to generate a high-frequency histogram, in which a color value of the high-frequency image separated from the at least one separated image and a number of pixels thereof are associated with each other, and a low-frequency histogram, in which a color value of the low-frequency image separated from the at least one separated image and a number of pixels thereof are associated with each other,
wherein the toner usage evaluation unit is further configured to:
obtain the toner usage of the high-frequency image based on the high-frequency histogram; and
obtain the toner usage of the low-frequency image based on the low-frequency histogram.

15. The image forming apparatus according to claim 2, wherein:
the color conversion unit includes a single black replacing unit configured to generate a single black replacement image by replacing an achromatic color pixel within the reference image with a single black pixel; and
the toner usage evaluation unit is further configured to obtain a usage of single black toner for printing the single black replacement image and usages of toner of other colors based on a relationship between each of color values regarding the single black toner and the toner of the other colors and a toner amount used per unit area.

16. The image forming apparatus according to claim 1, further comprising a billing unit configured to obtain a print charge for the subject image based on the toner usage and a set charge per toner unit amount.

17. A toner usage evaluation method, comprising:
a reference image generating unit converting a subject image into a reference image having a data amount smaller than the subject image; and
a toner usage evaluation unit obtaining a usage of toner for printing the subject image based on the reference image.

18. The toner usage evaluation method according to claim 17, further comprising color-converting the reference image, to generate a color-converted image, via a first color conversion table relating an input color value with an output color value.

19. A non-transitory computer-readable recording medium that stores a toner usage evaluation program code executed by a computer of an image forming apparatus, the toner usage evaluation program code comprising:
a first sub-program code that causes the computer to convert a subject image into a reference image having a data amount smaller than the subject image; and
a second sub-program code that causes the computer to obtain a usage of toner for printing the subject image based on the reference image.

20. The non-transitory computer-readable recording medium according to claim 19, further comprising a third sub-program code that causes the computer to color-convert the reference image, to generate a color-converted image, via a first color conversion table relating an input color value with an output color value.
